(19) United States
(12) Patent Application Publication
(10) Pub. No.: US 2007/0074926 A1
(43) Pub. Date: Apr. 5, 2007

(54) Power steering device

(75) Inventors: Toru Takahashi, Kanagawa (JP); Toshimitsu Sakaki, Kanagawa (JP); Tadaharu Yokota, Kanagawa (JP); Kazuya Yamano, Kanagawa (JP); Kyoko Honbo, Ibaraki (JP); Masanori Sakai, Ibaraki (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 11/487,356

(22) Filed: Jul. 17, 2006

(30) Foreign Application Priority Data
Oct. 3, 2005 (JP) 2005-290069

(51) Int. Cl. B62D 5/06

(52) U.S. Cl. 180/417

(57) ABSTRACT

A power assist mechanism is provided that assists operation of a steering mechanism when receiving a pressurized hydraulic fluid. A hydraulic pump feeds the power assist mechanism with the pressurized hydraulic fluid when driven. An electric motor drives the hydraulic pump. A battery unit is provided for energizing the electric motor. A control unit is provided for controlling the electric power from the battery unit to the electric motor. The battery unit comprises a plurality of lead-acid batteries that are connected in series. Each lead-acid battery comprises a spirally wound positive plate, a spirally wound negative plate, a spirally wound insulating plate that is spirally wound and sandwiched between the positive and negative plates, a battery case that puts therein the spirally wound positive, negative and insulating plates and an electrolyte that is provided in the battery case.

### BACKGROUND OF THE INVENTION

1. Field of the Invention

The present invention relates in general to power steering devices of wheeled motor vehicles and more particularly to the power steering devices of a type that assists the driver's steering action with the aid of a hydraulic power assist mechanism powered by an electric motor.

2. Description of the Related Art

Hitherto, various power steering devices have been proposed and put into practical use in the field of the wheeled motor vehicles.

Some of the power steering devices are of a type that comprises a steering mechanism through which turning of a steering wheel is transmitted to steered road wheels of a vehicle, a hydraulic power cylinder that assists operation of the steering mechanism when receiving a pressurized hydraulic fluid thereinto, a reversible hydraulic pump that feeds the hydraulic power cylinder with the pressurized hydraulic fluid, an electric motor that drives the hydraulic pump, a battery that produces an electric power for energizing the electric motor, and a control unit that controls operation of the electric motor in accordance with an operation condition of the vehicle and that of the engine.

### SUMMARY OF THE INVENTION

In the above-mentioned type power steering devices, the electric motor is designed to operate at a high speed for effectively driving the reversible hydraulic pump at the time when the steering wheel is turned by the driver for steering the vehicle. While, when the vehicle runs straightly, that is, when the steering wheel is kept at a neutral position, the electric motor does not operate. Accordingly, when, with the vehicle straightly running keeping the steering wheel at the neutral position, the steering wheel is turned right or left by the driver, the electric motor is forced to increase its rotation speed from zero to a high speed in a short time. In such case, the battery is subjected to a great voltage drop, and thus the battery fails to speedily run the electric motor in the desired manner.

It is therefore an object of the present invention to provide a power steering device of the above-mentioned type, which can provide the electric motor with a quick response in rotation speed from zero to a high speed when, with the vehicle running straightly, the steering wheel is turned from the neutral position.

In accordance with a first aspect of the present invention, there is provided a power steering device of a motor vehicle which has a steering wheel and steered road wheels. The power steering device comprises a steering mechanism through which turning of the steering wheel is transmitted to the steered road wheels of the vehicle; a power assist mechanism that assists the operation of the steering mechanism when receiving a pressurized hydraulic fluid; a hydraulic pump that feeds the power assist mechanism with the pressurized hydraulic fluid when driven; an electric motor that drives the hydraulic pump when energized; a battery unit that produces an electric power for energizing the electric motor; a sensor member that senses both a toque applied to the steering mechanism through the steering wheel and a direction in which the steering wheel is turned; and a control unit that controls operation of the electric motor, the control unit being configured to control the electric power fed from the battery unit to the electric motor in accordance with the torque and the direction sensed by the sensor; wherein the battery unit comprises a plurality of lead-acid batteries that are connected in series, each lead-acid battery including a spirally wound positive plate, a spirally wound negative plate, a spirally wound insulating plate that is spirally wound and sandwiched between the positive and negative plates, a cylindrical battery case that puts therein the spirally wound positive, negative and insulating plates and an electrolyte that is provided in the cylindrical battery case.

In accordance with a second aspect of the present invention, there is provided a power steering device of a motor vehicle which has a steering wheel and steered road wheels. The power steering device comprises a steering mechanism through which turning of the steering wheel is transmitted to the steered road wheels; a hydraulic power cylinder having first and second work chambers defined therein, the power cylinder assigning the operation of the steering mechanism when receiving a pressurized hydraulic fluid in one of the first and second work chambers; a reversible hydraulic pump that has first and second intake/exhaust ports that are connected to the first and second work chambers of the hydraulic power cylinder respectively, the reversible hydraulic pump feeding one of the first and second work chambers with the pressurized hydraulic fluid when rotated in either one of normal and reversed directions; a three-phase electric motor that drives the reversible hydraulic pump when energized by a three-phase alternating current electric power; a battery unit that produces a direct current electric power; a sensor member that senses both a torque applied to the steering mechanism through the steering wheel and a direction in which the steering wheel is turned; and a control unit that is energized by the electric power and controls operation of the three-phase electric motor, wherein the control unit includes a section that inverts the direct current electric power from the battery unit to the three-phase alternating current electric power fed to the electric motor, and a section that controls the electric power from the battery unit to the electric motor in accordance with the torque and the direction that are sensed by the sensor member.

In accordance with a third aspect of the present invention, there is provided a power steering device of a motor vehicle which has a steering wheel and steered road wheels. The power steering device comprises a steering mechanism through which turning of the steering wheel is transmitted to the steered road wheels; a hydraulic power cylinder having first and second work chambers defined therein, the power cylinder assisting the operation of the steering mechanism when receiving a pressurized hydraulic fluid in one of the first and second work chambers; a reversible hydraulic pump that has first and second intake/exhaust ports that are connected to the first and second work chambers of the hydraulic power cylinder respectively, the reversible hydraulic pump feeding one of the first and second work chambers with the pressurized hydraulic fluid when rotated in either one of normal and reversed directions; an electric motor that rotates the reversible hydraulic pump in normal and reversed directions; a battery unit including a plurality of lead-acid batteries that are connected in series, each lead-acid battery comprising a spirally wound positive plate, a spirally wound negative plate, a spirally wound insulating plate that is spirally wound and sandwiched between the positive and negative plates, a battery case that puts therein the spirally wound positive, negative and insulating plates and an electrolyte that is provided in the battery case; a power module that controls an electric power that is produced by the battery unit and fed to the electric motor; a steering load detecting section that detects a steering load that is applied to the steering mechanism through the steering wheel; and a control module that controls the power module in accordance with the steering load detected by the steering load detecting section.

Other objects and advantages of the present invention will become apparent from the following description when taken in conjunction with the accompanying drawings.

### BRIEF DESCRIPTION OF THE DRAWINGS

FIG. 1 is a block diagram of a power steering device according to the present invention;

FIG. 2 is a battery unit used for energizing the power steering device of the invention, the battery including a plurality of lead-acid batteries connected in series;

FIG. 3 is a perspective view of one of the lead-acid batteries;

FIG. 4 is an enlarged and partially sectional view of the lead-acid battery;

FIG. 5 is an axially sectional view of a reversible hydraulic pump;

FIG. 6 is an enlarged plan view of the hydraulic pump with a second housing removed;

FIG. 7 is another axially sectional view of the reversible hydraulic pump, that is taken along the line VII-VII of FIG. 6;

FIG. 8 is a laterally sectional view of the hydraulic pump at a portion where a switch valve is provided;

FIG. 9 is an axially sectional view of an electric motor that is used for driving the reversible hydraulic pump;

FIG. 10 a diametrically sectional view of the electric motor, that is taken along the line X-X of FIG. 9;

FIG. 11 is a diagram showing the manner in which coils of three groups of stators of the electric motor are connected;

FIG. 12 is a diametrically sectioned view of the electric motor taken along the line XII-XII of FIG. 9, concretely showing the manner in which the coils of the three groups of stators of the motor are connected through three terminal connecting rings;

FIG. 13 is a block diagram of a control unit employed in the invention, showing a power module and a control module;

FIG. 14 is a block diagram of the control unit showing a connector module connected to the power and control modules;

FIG. 15 is a flowchart showing programmed operation steps executed by the control unit for checking operation of the power steering device of the invention;

FIG. 16 is a flowchart showing programmed operation steps executed for finding an abnormal condition of the power steering device of the invention;

FIGS. 17A and 17B are time charts respectively showing the performance of a battery used in the invention and that of a conventional battery, when practically used in a motor vehicle;

FIGS. 18A and 18B are time charts respectively showing-the characteristic of the battery used in the invention and that of the conventional battery, at the time when an engine of the motor vehicle is stopped; and

FIG. 19 is a graph showing both a torque efficiency of a high speed low torque type motor and that of a low speed high torque type motor.

### DETAILED DESCRIPTION OF THE INVENTION

In the following, a power steering device of the present invention will be described in detail with reference to the accompanying drawings.

For easy understanding, various directional terms, such as, right, left, upper, lower, rightward and the like are used in the following description. However, such terms are to be understood with respect to only drawing or drawings on which a corresponding part or portion is shown.

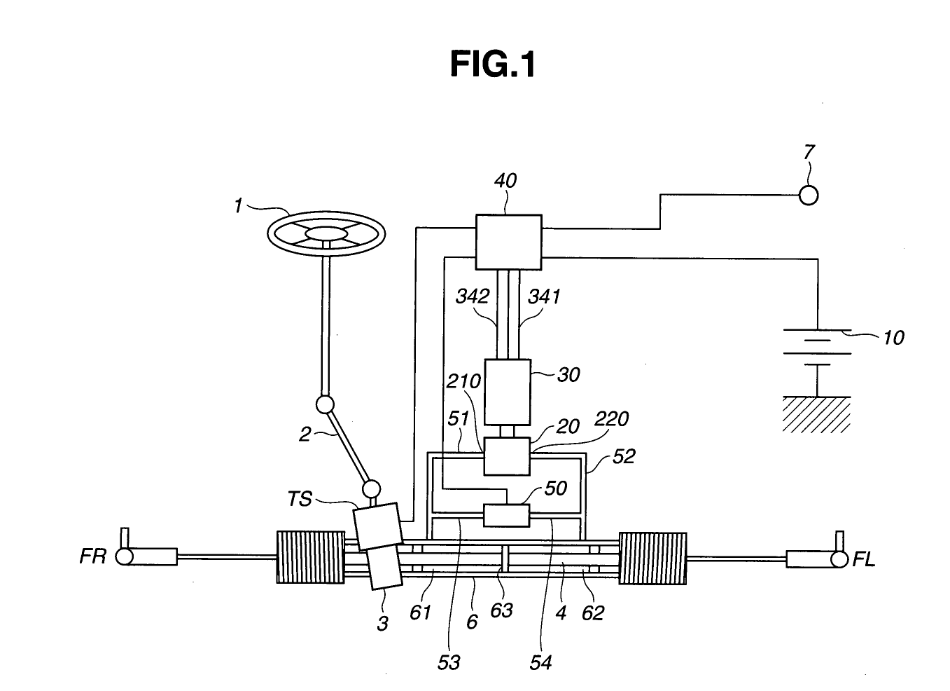

Referring to FIG. 1, there is schematically shown a power steering device of the present invention, which is practically applied to steered front right and front left road wheels FR and FL of a motor vehicle.

As is understood from FIG. 1, when a steering wheel 1 is handled or turned by a driver, the turning of steering wheel 1 is transmitted to a pinion 3 of a rack-and-pinion mechanism through a shaft 2. The turning of pinion 3 moves a rack 4 of the mechanism axially in right or left direction. The rightward or leftward movement of rack 4 brings about a steered movement of the front right and left road wheels FR and FL of the vehicle. As will be understood from the following, the rightward or leftward movement of rack 4 is assisted by a power assist mechanism.

To shaft 2, there is mounted a sensor member TS that detects both a torque that is applied to shaft 2 by the driver through steering wheel 1 and a direction in which shaft 2 (viz., steering wheel 1) is turned. Information signals representing the detected torque and rotation direction are fed to a control unit 40.

The power assist mechanism comprises generally a three phase electric motor 30 controlled by control unit 40, a reversible hydraulic pump 20 driven by electric motor 30 and a hydraulic power cylinder 6 incorporated with rack 4.

As shown, hydraulic power cylinder 6 is equipped with an axially movable piston 63 by which the interior of hydraulic power cylinder 6 is divided into first and second work chambers 61 and 62. The above-mentioned rack 4 is connected to piston 63 to move therewith.

First and second work chambers 61 and 62 are respectively connected to first and second intake/exhaust ports 210 and 220 of reversible hydraulic pump 20 through first and second hydraulic passages 51 and 52. Thus, by feeding first and second work chambers 61 and 62 with different pressures by driving hydraulic pump 20, piston 63 is biased to move in a certain direction, which assists the axial movement of rack 4, that is, assists the driver in turning steering wheel 1.

As shown, first and second hydraulic passages 51 and 52 are connected to an electromagnetic switch valve 50 through third and fourth hydraulic passages 53 and 54.

Electromagnetic switch valve 50 is a normally closed type, which serves as a fail-safe member. That is, under normal condition, switch valve 50 is kept closed by control unit 40. While, upon finding an abnormal condition of the power steering device, control unit 40 opens switch valve 50 to directly connect first and second hydraulic passages 51 and 52 thereby permitting a free movement of a highly pressurized fluid in first or second work chamber 61 or 62 to the other work chamber 62 or 61. Upon this, a so-called manual steering becomes possible by the driver.

Control unit 40 is energized by a battery unit 10 and receives various information signals which are, for example, the torque representing signal from sensor member TS, the steering wheel rotation direction representing signal from sensor member TS, an engine speed representing signal from an ignition device (not shown) and a vehicle speed representing signal from a vehicle speed sensor 7, etc.,.

By processing the information signals received thereto, control unit 40 calculates an assisting force that is to be applied to rack 4. Based on the calculated assisting force, control unit 40 feeds electric motor 30 with a corresponding instruction signal.

Electric motor 30 is of a brushless type that is excellent in an inertial characteristic. With usage of this type electric motor 30, the operation of the reversible hydraulic pump 20 is smoothly and effectively carried out, which improves a steering feeling that the driver has when handling steering wheel 1.

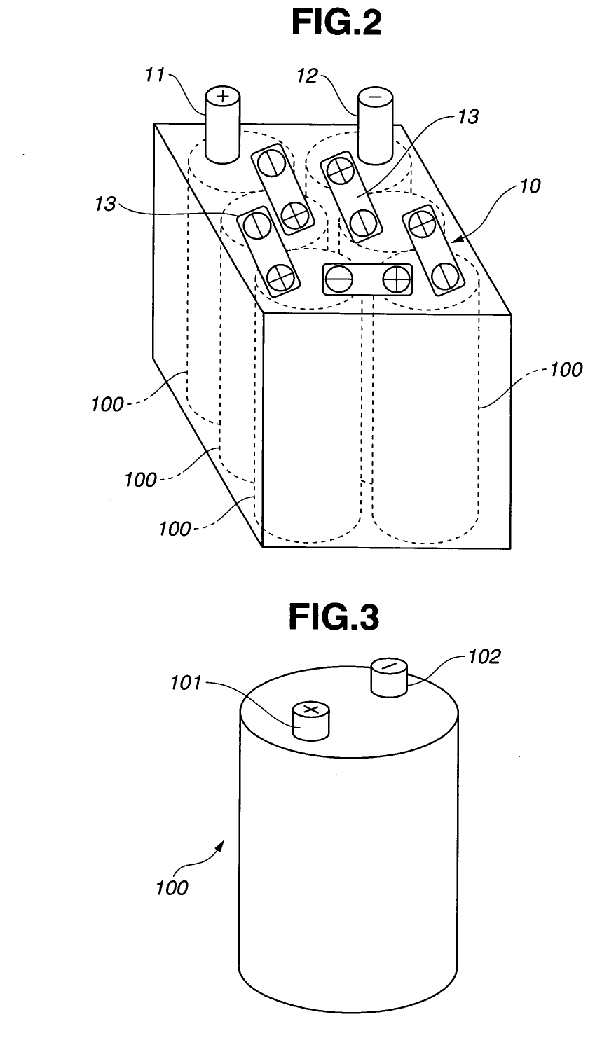

Referring to FIGS. 2, 3 and 4, there are respectively shown a perspective view of battery unit 10, a perspective view of one of lead-acid batteries 100 that constitute battery unit 10 and a partially sectioned view of lead-acid battery 100.

As shown in FIG. 2, battery unit 10 is constructed by combining six lead-acid batteries 100 that are connected in series. Battery unit 10 has positive (or plus) and negative (or minus) terminals 11 and 12 between which a voltage of 14V is produced. As shown, all lead-acid batteries 100 are electrically connected through connecting pieces 13.

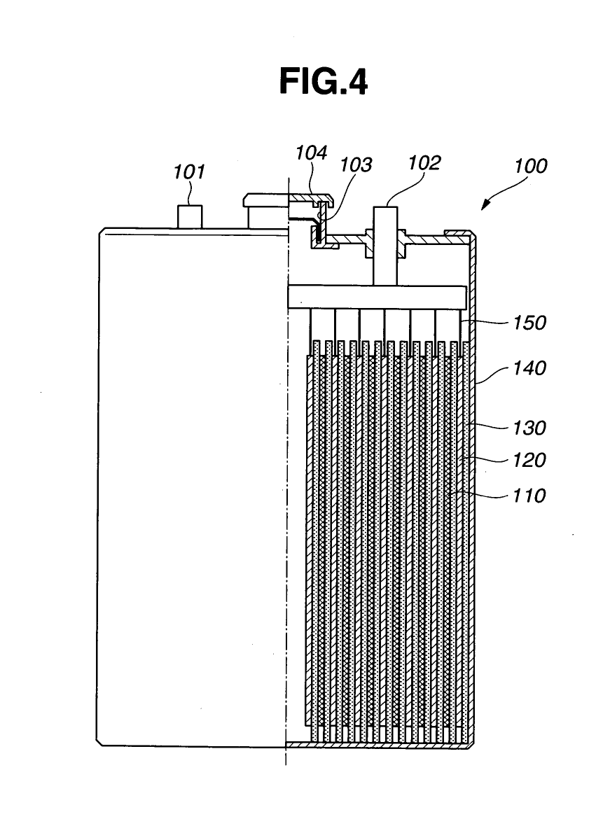

As will be understood from FIG. 4, each lead-acid battery 100 is of a spirally wound type that comprises a spirally wound positive plate 110, a spirally wound negative plate 120 and a spirally wound insulating plate 130 that is spirally wound and sandwiched between positive and negative plates 110 and 120. These spirally wound plates 110, 120 and 130 are concentrically disposed in a cylindrical battery case 140 that is filled with an electrolyte. Given portions of positive plate 110 are connected through wires (not shown) to a positive terminal 101 that has an exposed head and given portions of negative plate 120 are connected through wires 150 to a negative terminal 102 that has an exposed head. Denoted by numeral 103 is an inlet port provided on an upper wall of battery case 140, through which the electrolyte is poured into battery case 140. The inlet port 103 can be detachably closed by a lid 104.

The spirally wound positive plate 110 of each lead-acid battery 100 may have an area of about 1,500 to 15,000 cm².

It is to be noted that the area of 1,500 to 15,000 cm² corresponds to about 1,700 to 17,000 cm² of parallelly arranged flat positive plates of a conventional rectangular parallelopiped battery of which four flat walls have each a length equal to the diameter of the cylindrical battery case 140.

It is also to be noted that the number of lead-acid batteries 100 is so determined as to cause battery unit 10 to keep the voltage higher than 12V even if an electric discharge in the scale of 100 A takes places.

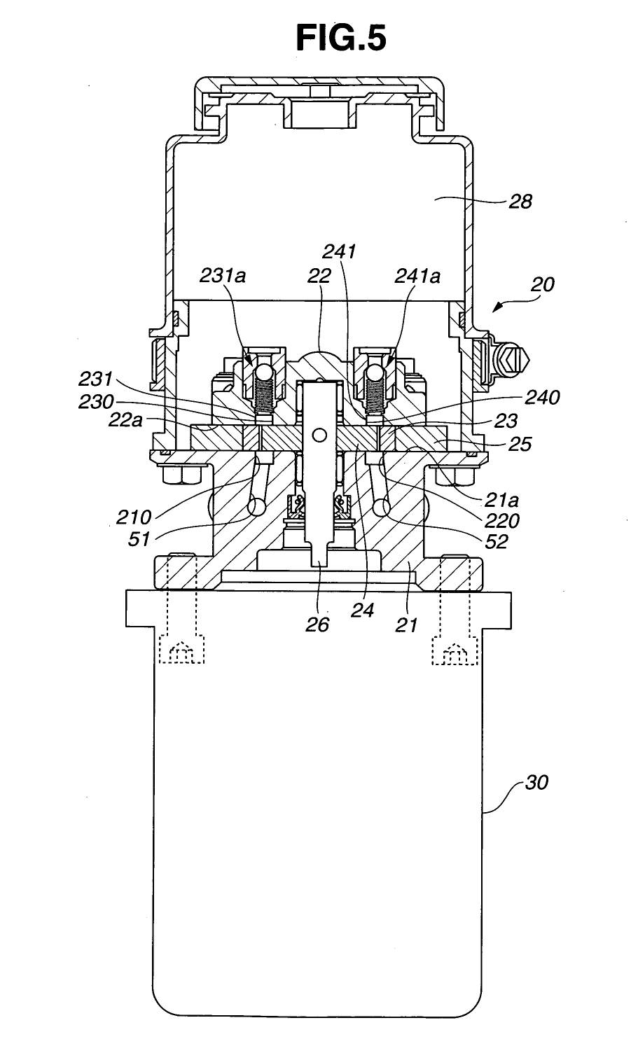

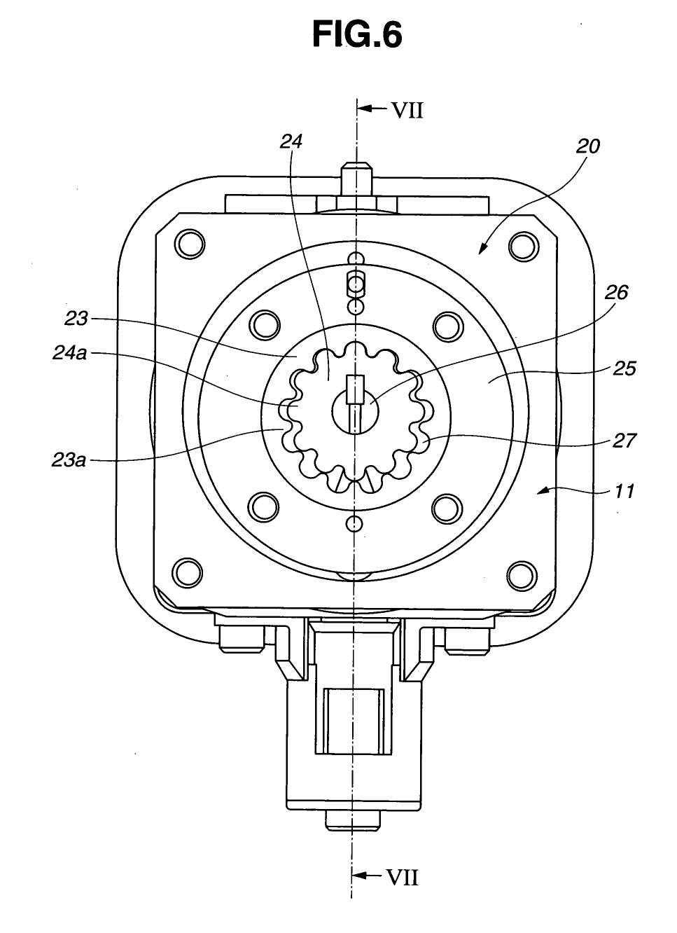

Referring to FIGS. 5 to 12, particularly FIGS. 5 and 6, there is shown the reversible hydraulic pump 20 in a sectional manner.

As shown in FIG. 5, hydraulic pump 20 comprises first and second housings 21 and 22 that are assembled in a manner to define therebetween a certain clearance. More specifically, the certain clearance is defined between a flat upper surface 21a of first housing 21 and a flat lower surface 22a of second housing 22.

Within the clearance, there is installed a cam ring 25 that has a circular center opening, as is seen from FIG. 6. Within the circular center opening of cam ring 25, there is rotatably received an outer rotor 23 that has a toothed inner opening. Within the toothed inner opening of outer rotor 23, there is rotatably received an inner rotor 24 that has a toothed outer wall meshed with the toothed inner opening of outer rotor 23. The detailed construction of cam ring 25, outer rotor 23 and inner rotor 24 will be described hereinafter.

As is seen from FIGS. 5 and 6, a drive shaft 26 passes through a center portion of inner rotor 24 for driving inner rotor 24.

As is understood from FIG. 6 and will become apparent as the description proceeds, rotation of inner rotor 24 about its center induces a circular traveling or motion of outer rotor 23 around inner rotor 24 for producing a volume variable work chamber 27 between the two rotors 24 and 23, which serves as a pumping means. More specifically, as shown in FIG. 6, outer rotor 23 is eccentrically arranged with respect to inner rotor 24 and cam ring 25 rotatably supporting outer rotor 23 is radially movably supported on first housing 21 through spring members.

Referring back to FIG. 5, first housing 21 is formed, at diametrically opposed portions of flat upper surface 21a with respect to the axis of drive shaft 26, with first and second intake/exhaust ports 210 and 220 each being connected with the volume variable work chamber 27 (see FIG. 6) defined between outer and inner rotors 23 and 24. As will become apparent as the description proceeds, each of first and second intake/exhaust ports 210 and 220 serves as an intake port or exhaust port in accordance with the direction in which drive shaft 26 rotates.

As is seen from FIG. 5, second housing 22 is formed, at diametrically opposed portions of the flat lower surface 22a with respect to the axis of drive shaft 26, with first and second feeding ports 230 and 240 each being connected with the volume variable work chamber 27.

First housing 21 is formed with first and second hydraulic passages 51 and 52 that are lead to first and second intake/exhaust ports 210 and 220 respectively. As has been mentioned hereinabove, these first and second hydraulic passages 51 and 52 are connected to first and second work chambers 61 and 62 of hydraulic power cylinder 6 (see FIG. 1). First housing 21 is mounted on a base portion of electric motor 30 in a such a manner that drive shaft 26 of hydraulic pump 20 is driven by a power produced by electric motor 30.

Second housing 22 is projected in a reservoir tank 28 that is connected to first and second feeding ports 230 and 240 through respective passages 231 and 241. As shown, each of the passages 231 and 241 is provided with a check valve 231a or 241a that permits only one way flow from reservoir tank 28 to first or second feeding port 230 or 240.

The construction of hydraulic pump 20 is much clearly understood from FIG. 6 which is a plan view of hydraulic pump 20 with second housing 22 removed.

As is seen from FIG. 6, outer rotor 23 is formed with an internal gear 23a and inner rotor 24 is formed with an external gear 24a. In the illustrated embodiment, the number of the teeth of internal gear 23a is greater than that of the external gear 24a by one. As shown, inner rotor 24 is received in outer rotor 23 having the teeth of the respective gears 24a and 23a partially but operatively meshed.

As has been mentioned hereinabove, first and second intake/exhaust ports 210 and 220 are arranged at respective positions that are exposed to respective given portions of the volume variable work chamber 27 that is defined between the internal and external gears 23a and 24a. That is, in accordance with a direction of rotation of drive shaft 26, that is, rotation of inner rotor 24, each of intake/exhaust ports 210 and 220 serves as an intake port or exhaust port.

That is, when inner rotor 24 and thus outer rotor 23 are rotated or turned in a counterclockwise direction in FIG. 6, a left half of volume variable work chamber 27 exhibits a volume increasing process and a right half of the chamber 27 exhibits a volume reducing process. Thus, in this case, intake/exhaust port 210 serves as an intake port and the other intake/exhaust port 220 serves as an exhaust port. While, when inner rotor 24 and thus outer rotor 23 are rotated or turned in a clockwise direction in FIG. 6, intake/exhaust port 220 serves as an intake port and the other intake/exhaust port 210 servers as an exhaust port for substantially same reasons as has been mentioned hereinabove.

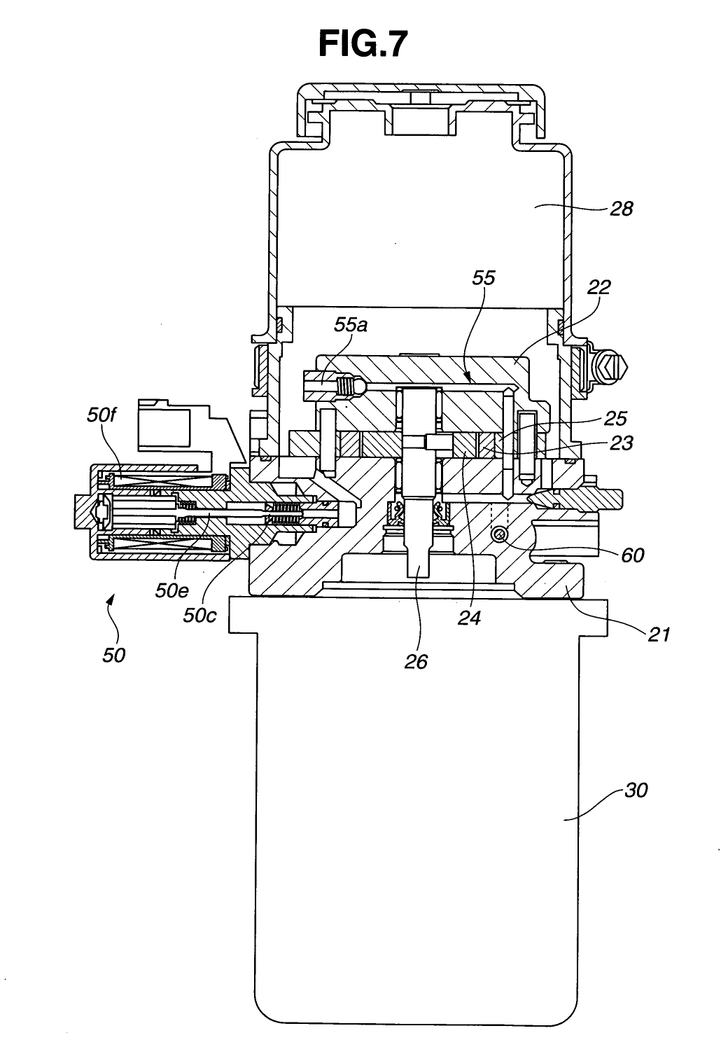

The construction of the above-mentioned hydraulic pump 20 is much clearly understood from FIG. 7 which is a sectional view taken along the line VII-VII of FIG. 6.

As is seen from FIG. 7, a spool valve 60 is provided in first housing 21, to which the above-mentioned first and second hydraulic passages 51 and 52 are connected. A return passage 55 is provided in second housing 22, through which first and second hydraulic passages 51 and 52 are connected to the above-mentioned reservoir tank 28. Return passage 55 is equipped with a check valve 55a that permits only one way flow from first or second hydraulic passage 51 or 52 to reservoir tank 28.

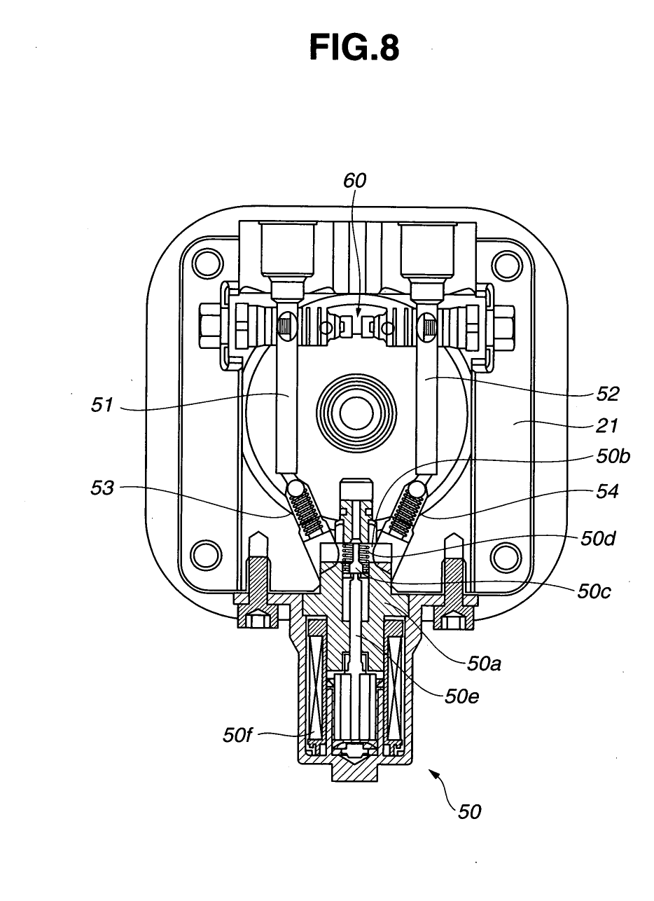

As shown in FIGS. 7 and 8, the above-mentioned electromagnetic switch valve 50 is mounted on a side wall of first housing 21. As has been mentioned hereinabove, electromagnetic switch valve 50 functions to selectively connect and disconnect first and second hydraulic passages 51 and 52 upon receiving instruction signals from control unit 40.

As is best seen from FIG. 8, electromagnetic switch valve 50 generally comprises a body 50a that has a passage 50b to which leading ends of third and fourth hydraulic passages 53 and 54 are connected. A valve head member 50c is axially movably installed in the passage 50b and biased by a coil spring 50d in a direction of close the passage 50b. Thus, when valve head member 50c receives no external force, the switch valve 50 takes its OFF position disconnecting first and second hydraulic passages 51 and 52. Electromagnetic switch valve 50 further comprises an electromagnetic actuator that, upon energization, moves valve head member 50c in a direction to open the passage 50b against the force of coil spring 50d. The actuator comprises an axially movable push rod (or armature rod) 50e that has a leading end contactable with valve head member 50c and a coil 50f that is arranged to surround an enlarged base portion of push rod 50e. Upon energization, coil 50f moves push rod 50e causing the same to push valve head member 50c against coil spring 50d. In this condition, the switch valve 50 takes its ON position connecting first and second hydraulic passages 51 and 52.

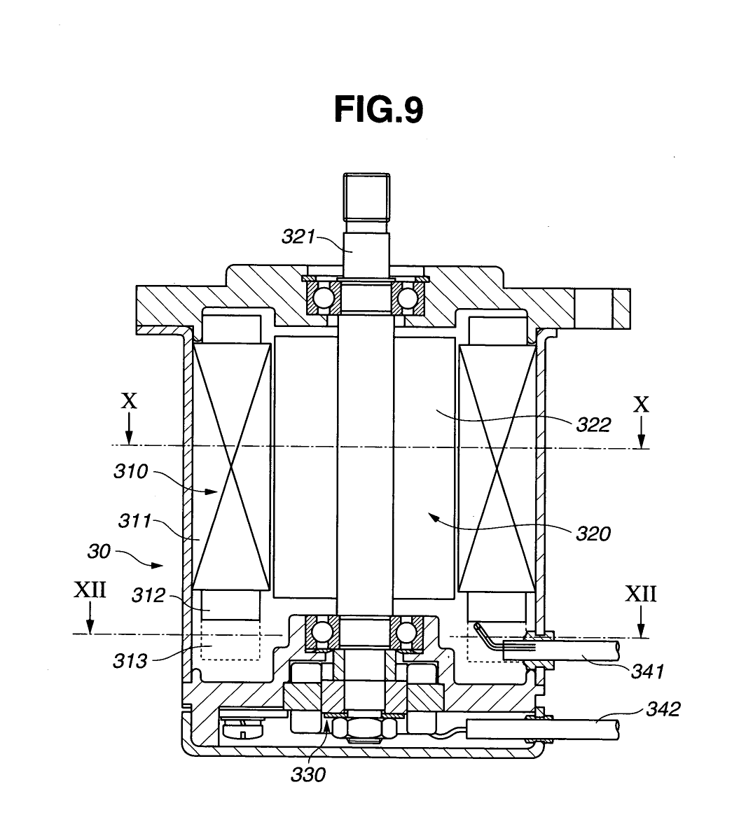

Referring to FIG. 9, there is shown the detail of electric motor 30.

As shown, electric motor 30 is of a brushless type, comprising a stator 310 that surrounds a rotor unit 320 of which rotational position is sensed by a rotational position sensor (RPS) 330. Stator 310 comprises stator cores 311 each having a stator coil 312 wound thereon. Terminal ends of stator coils 312 are connected to some of three terminal connecting rings (CR) 313 to which power cables 341 from an after-mentioned power module 410 of control unit 40 are connected. Rotor unit 320 comprises an output shaft 321 and a plurality of magnets 322 that are arranged to surround output shaft 321. It is to be noted that an upper end of output shaft 321 is connected to the above-mentioned drive shaft 26 (see FIG. 5) of the hydraulic pump 20. Denoted by numeral 342 is a cable through which the information signal produced by rotational position sensor 330 is fed to control unit 40.

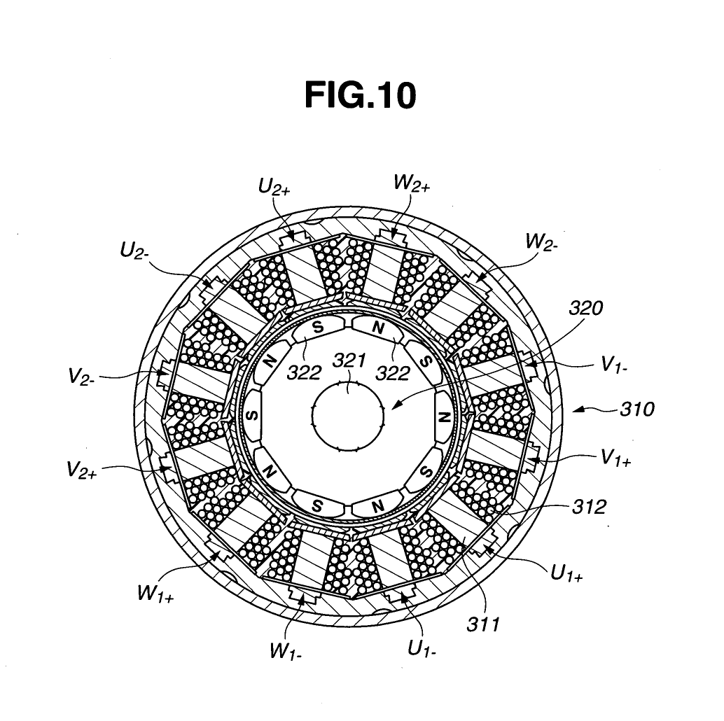

The detail of electric motor 30 is much clearly understood from FIG. 10 that is a sectional view taken along the line X-X of FIG. 9.

As is seen from FIG. 10, stator 310 has twelve stator cores 311. As shown, the twelve stator cores 311 are classed into three groups each having four stator cores 311. The three groups are U-phase group, V-phase group and W-phase group. As shown, rotor unit 320 has ten magnets 322 that are arranged to surround output shaft 321 placing the N and S poles thereof alternately.

The four stator cores 311 of the U-phase group are denoted by U1+, U1−, U2+ and U2− respectively, and as shown, the two stator cores U1+ and U2− are arranged at diametrically opposed positions with respect to the axis of output shaft 321, and the other two stator cores U1− and U2+ are arranged at diametrically opposed positions. The four stators 311 of the V-phase group are denoted by V1+, V1−, V2+ and V2− respectively, and as shown, the two stator cores V1+ and V2− are arranged at diametrically opposed positions with respect to the axis of output shaft 321, and the other two stator cores V1− and V2+ are arranged at diametrically opposed positions. The four stators 311 of the W-phase group are denoted by W1+, W1−, W2+ and W2− respectively, and as shown, the two stator cores W1+ and W2− are arranged at diametrically opposed positions with respect to the axis of output shaft 321, and the other two stator cores W1− and W2+ are arranged at diametrically opposed positions.

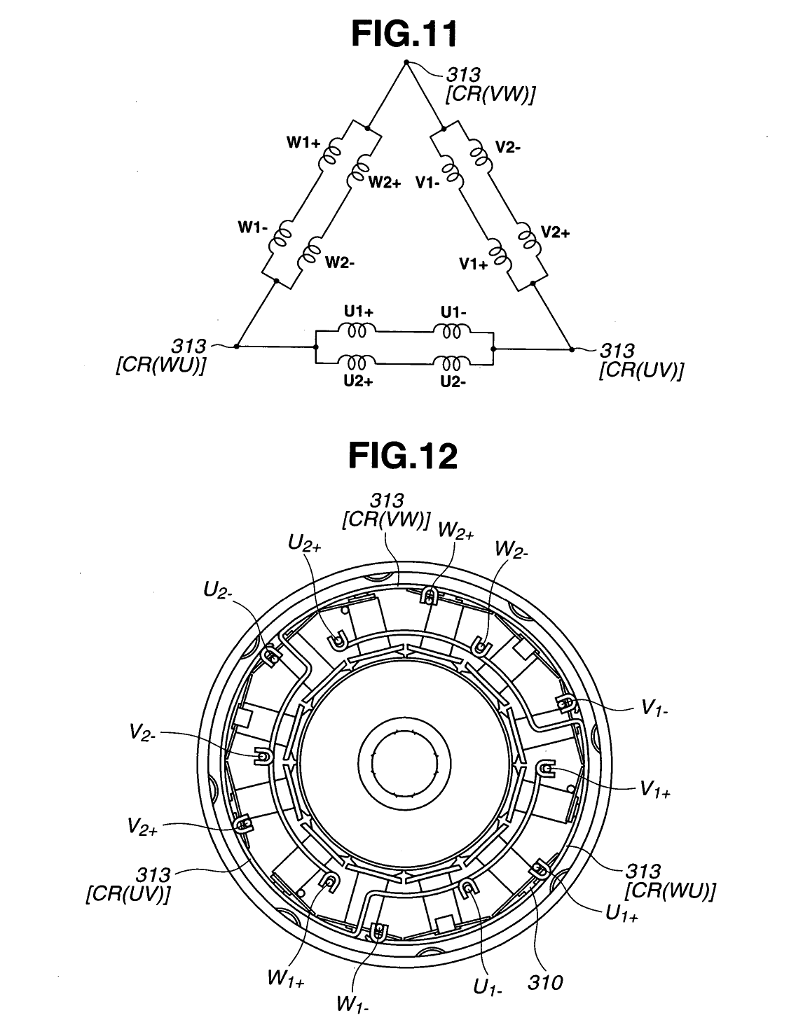

Referring to FIG. 11, there is diagrammatically shown the manner in which terminals of stator coils 312 of the above-mentioned twelve stator cores 311 are connected for feeding the stator coils 312 with a three-phase alternating current.

As shown, in case of the stator cores U1+, U1−, U2+ and U2− of the U-phase group, the two coils 312 for stator cores U1+ and U1− are connected in series and the two coils 312 for stator cores U2+ and U2− are connected in series, and these two tandem circuits are connected in parallel to constitute a so-called U-circuit. Like this, in case of stator cores V1+, V1−, V2+ and V2− of the V-phase group and stator cores W1+, W1−, W2+ and W2−of the W-phase group, so-called V- and W-circuits are constituted. These three circuits, viz., U-circuit, V-circuit and W-circuits, are connected in a delta connection manner to constitute a triangle circuit, as shown. The three connection points of the triangle circuit are connected to three terminal connecting rings 313 (or CR(UV), CR(VW) and CR(WU)) respectively.

Referring to FIG. 12, there is shown a sectional view of a portion of electric motor 30 where the terminals of the twelve stator coils 312 are connected to the three terminal connecting rings 313 (or CR(UV), CR(VW) and CR(WU)).

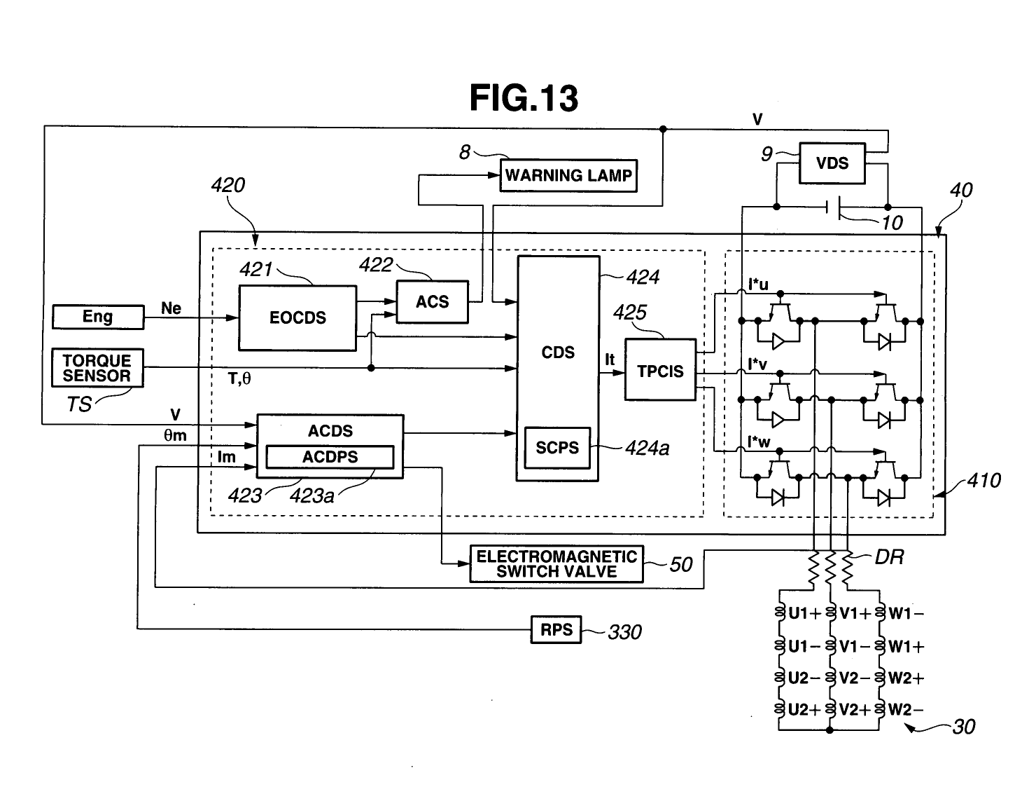

Referring to FIG. 13, there is shown the detail of control unit 40.

Control unit 40 comprises a power module 410 that serves as an inverter, and a control module 420 that controls power module 410. That is, due to function of control module 420 and power module 410, the direct current (viz., DC) from battery unit 10 is inverted into a three phase alternating current and fed to the electric motor 30.

Control module 420 is a micro-computer that generally comprises a central processing unit (CPU), a random access memory (RAM), a read only memory (ROM) and input and output interfaces. More specifically, control unit 40 is constructed to have an engine operation condition detecting section (EOCDS) 421, an alarm control section (ACS) 422, an abnormal condition detecting section (ACDS) 423, a current decided section (CDS) 424 and a three phase current inverting section (TPCIS) 425. Abnormal condition detecting section (ACDS) 423 has an abnormal condition detection inhibiting section (ACDPS) 423a, and current deciding section (ACDS) 424 has a steering control inhibiting section (SCPS) 424a.

Based on an engine speed Ne, engine operation condition detecting section 421 judges whether the engine is under ON or OFF condition and feeds a corresponding signal to both alarm control section 422 and current deciding section 424. Based on a torque signal T from torque sensor TS (see FIG. 1) and a steering angle signal θ from a steering angle sensor, alarm control section 422 judges whether a steering action is actually carried out by a driver or not. That is, when, under OFF condition of the engine, the steering action is made, alarm control section 422 energizes a warning lamp 8 to let the driver know an excessive steering load under stopping of the engine.

Abnormal condition detecting section 423 feeds current deciding section 424 with a motor drive instruction signal S irrespective of work of torque sensor TS. Abnormal condition detecting section 423 detects a current value Im of electric motor 30 by using shunt resistors, and based on the detected current value Im, the section 423 judges whether the electric motor 30 is in an abnormal condition or not. When abnormal condition of the motor 30 is detected, the section 423 opens the above-mentioned electromagnetic switch valve 50 (see FIG. 1).

As shown in FIG. 13, a voltage detecting section (VDS) 9 detects the voltage of battery unit 10 and feeds a corresponding voltage signal V to abnormal condition detecting section 423. When the sensed voltage V is lower than a predetermined value, abnormal condition detection inhibiting section 423a inhibits the operation of abnormal condition detecting section 423. With this, excessive voltage drop of battery unit 10 is suppressed and at the same time, misdiagnosis for electric motor 30 by the section 423 is suppressed.

Based on ON/OFF condition of the engine, voltage V of battery unit 10, torque T and steering angle θ, current deciding section 424 decides a target value “It” of current (which will be referred to “target current value” hereinafter) to be fed to electric motor 30 and feeds a corresponding signal to three phase current inverting section 425. Because of the nature of battery unit 10 that has a less voltage drop, battery unit 10 can produce a power that is sufficient for driving electric motor 30. When the engine is in OFF condition, an alternator does not produce electric power. Thus, under such condition, the target current value “It” decided by current deciding section 424 should be smaller than a current decided when the engine is in ON condition. With this measure, excessive voltage drop of battery unit 10 can be avoided.

When, under OFF condition of the engine, the voltage V of battery unit 10 shows a value lower than a predetermined value, steering control inhibiting section 424a inhibits operation of electric motor 30 thereby to stop the power assist to the driver's steering action. Since the alternator does not produce electric power when the engine is under OFF condition, such inhibiting action eliminates the excessive voltage drop of battery unit 10. In order to avoid a rapid drop in steering feeling, the steering control inhibiting operation is carried out by gradually reducing the target current value “It”.

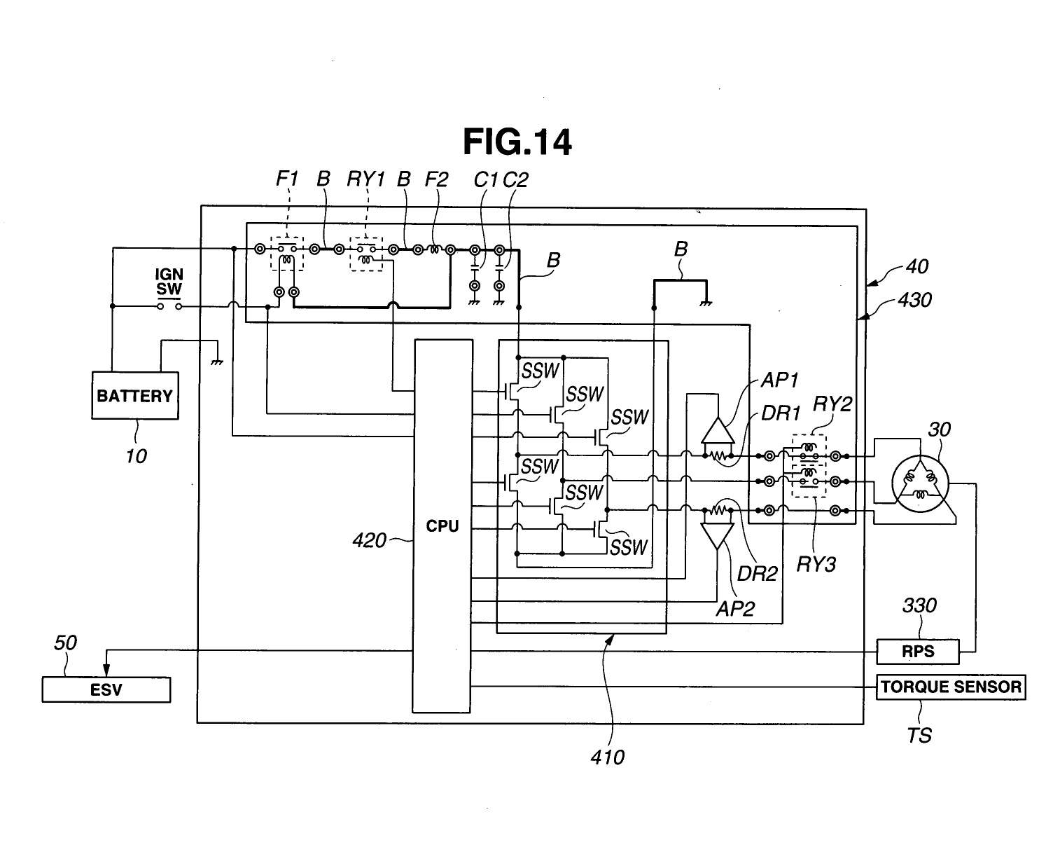

Referring to FIG. 14, there is shown a circuit system of control unit 40. In the circuit system shown, thick lines indicate bus bars B and double circles indicate the portions where welding is practically made.

That is, in addition to the above-mentioned power module 410 and control module 420, control unit 40 has a connector module 430 that is electrically connected to power module 410.

As shown, by the function of semiconductor switching elements SSW, power module 410 produces a three-phase alternating current that is to be fed to electric motor 30, and by the function of shunt resistors DR1 and DR2, power module 410 detects current values of the three-phase alternating current. The current values detected are fed back to control module 420 through respective amplifiers AP1 and AP2. As has been mentioned hereinabove, control module 420 calculates the target current value “It” and feeds a corresponding instruction signal to power module 410. Furthermore, when abnormal condition of the motor 30 is detected, control module 420 opens the above-mentioned electromagnetic switch valve 50 (see FIG. 1).

Connector module 430 comprises first, second and third relays RY1, RY2 and RY3, first and second filters F1 and F2 and first and second condensers C1 and C2 which are arranged in such a manner as is shown in FIG. 14. Terminals of these elements RY1, RY2, RY3, F1, F2, C1 and C2 are connected to bus bars B (illustrated by thick lines) for achieving the electric connection with power module 410. Each bus bar B is in the shape of an elongate plate and has portions to which the terminals are welded.

The three relays RY1, RY2, and RY3 are of an overcurrent responsive type. That is, first relays RY1 functions to break the connection between battery unit 10 and power module 410 when an excessive current is fed to power module 410 from battery unit 10. Second and third relays RY2 and RY3 function to break the connection between power module 410 and electric motor 30 when an excessive current is applied to motor 30.

Filters F1 and F2 are of a noise reduction type. That is, first filter F1 functions to eliminate noises that would be produced in a circuit directly connected to battery unit 10. With the aid of condensers C1 and C2, second filter F2 functions to eliminate noises which would be produced when the semi-conductor switching elements SSW operate.

When the engine is in its OFF condition, the alternator does not generator electric power and thus under such condition, battery unit 10 is not charged. Thus, if the steering assist is effected when the engine is in OFF condition, discharge of battery unit 10 is accelerated, which brings about a marked voltage drop and thus affects normal steering assist operation.

Accordingly, as has been mentioned hereinabove, when the engine is in OFF condition, the target current value “It” for electric motor 30 is reduced for lightening the work load of battery unit 10. When the voltage V of battery unit 10 becomes lower than a predetermined low level Va, the target current value “It” is determined 0 (zero) thereby to inhibit the steering assist.

Is In case of making the target current value “It” 0 (zero), the value of the target current value “It” should be gradually reduced for avoiding deterioration in steering feeling. Furthermore, when steering wheel 1 is handled when the engine is in OFF condition, the warning lamp 8 is energized to let the driver know the excessive steering load under stopping of the engine.

When the power steering device has any trouble, electromagnetic switch valve 50 is opened to directly connect first and second work chambers 61 and 62 of hydraulic power cylinder 6 (see FIG. 1). Under this condition, a so-called manual steering is possible by the driver. For this fail-safe operation, it is necessary to drive hydraulic pump 20 irrespective of presence/absence of steering torque “T”. That is, by driving hydraulic pump 20, a check is made for checking whether the power steering device has a trouble or not.

As will be understood from FIG. 1, if electromagnetic switch valve 50 is kept closed at the time when, for checking the power steering device, hydraulic pump 20 is driven, one of first and second work chambers 61 and 62 of hydraulic power cylinder 6 is fed with a pressurized fluid. In this case, the steered front road wheels are steered against the driver's will. Accordingly, at the time of checking the power steering device, electromagnetic switch valve 50 should be opened.

Because of the construction as mentioned hereinabove, battery unit 10 can exhibit a high discharge characteristic. Thus, even when, like a case just after engine starting, the alternator can not generate a sufficient quantity of electricity, battery unit 10 can operate electric motor 30 sufficiently. Accordingly, even when the checking for the power steering device is carried out just after engine starting, the checking is properly carried out.

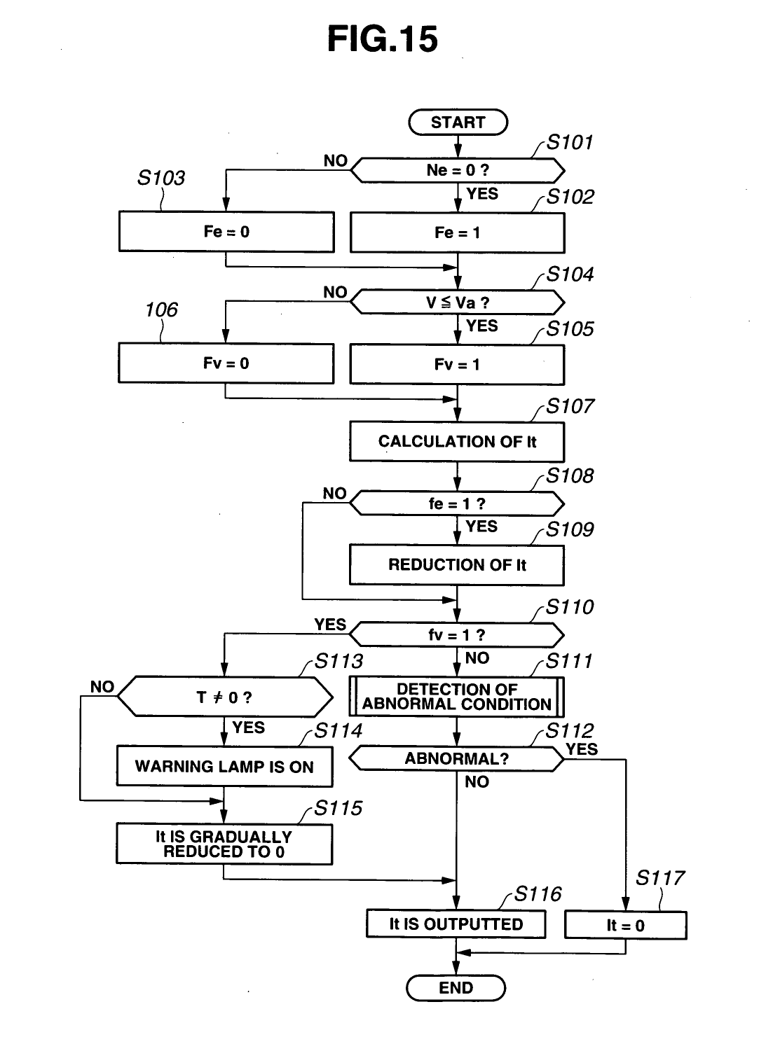

In the following, programmed operation steps for checking operation of the power steering device will be described in detail with reference to the flowchart of FIG. 15.

At step S101, judgment is carried out as to whether the engine speed Ne is 0 (zero) or not. If YES, that is, when the engine speed Ne is 0 (zero), the operation flow goes to step S102 judging that the engine is in OFF condition. While, if NO, that is, when the engine speed Ne is not 0 (zero), the operation flow goes to step S103 judging that the engine is in ON condition.

At step S102, an engine OFF flag “Fe” is set to 1, and the operation flow goes to step S104. While, at step S103, the engine OFF flag “Fe” is set to 0 (zero), and the operation flow goes to step S104.

At step S104, judgment is carried out as to whether or not the battery voltage “V” is equal to or lower than a predetermined value “Va”. If YES, the operation flow goes to step S105 judging that battery unit 10 shows a certain voltage drop. If NO, the operation flow goes to step S106 judging that battery unit 10 does not show a voltage drop.

At step S105, a battery voltage drop flag “Fv” is set to 1, and the operation flow goes to step S107. While, at step S106, the battery voltage drop flag “Fv” is set to 0 (zero), and the operation flow goes to step S107.

At step S107, a target current value “It” is calculated, and the operation flow goes to step S108.

At step S108, judgment is carried out as to whether the engine OFF flag “Fe” is 1 or not. If YES, the operation flow goes to step S109 judging that the engine is in OFF condition. While, if NO, the operation flow goes to step S110 judging that the engine is in ON condition.

At step S109, the target current value “It” is reduced, and the operation flow goes to step S110.

At step S110, judgment is carried out as to whether the battery voltage drop flag “Fv” is 1 or not. If YES, the operation flow goes to step S113 judging that battery unit 10 shows a certain voltage drop. While, if NO, the operation flow goes to step S111 judging that battery unit 10 does not show a voltage drop.

At step S111, an abnormal condition detecting control is carried out, and the operation flow goes to step S112.

At step S112, judgment is carried out as to whether the power steering device has any trouble or not. If YES, the operation flow goes to step S117. While, if NO, the operation flow goes to step S116.

At step S113, judgment is carried out as to whether or not a detected steering torque is not 0 (zero). If YES, that is, when the detected steering toque is not 0 (zero), that is, when the steering wheel 1 is handled by a driver, the operation flow goes to step S114 to energize a warning lamp 8. Then, the operation flow goes to step S115. If NO at step S113, that is, when the detected steering torque is 0 (zero), that is, when the steering wheel 1 is not handled by the driver, the operation flow goes to step S115.

At step S115, the target current value “It” is gradually reduced (finally to 0 (zero)), then the operation flow goes to step S116.

At step S116, the target current value “It” is outputted, that is, practically fed to electric motor 30, and the control is finished.

At step S117, the target current value “It” is set to 0 (zero), and the control is finished. That is, in this case, electric motor 30 is not energized.

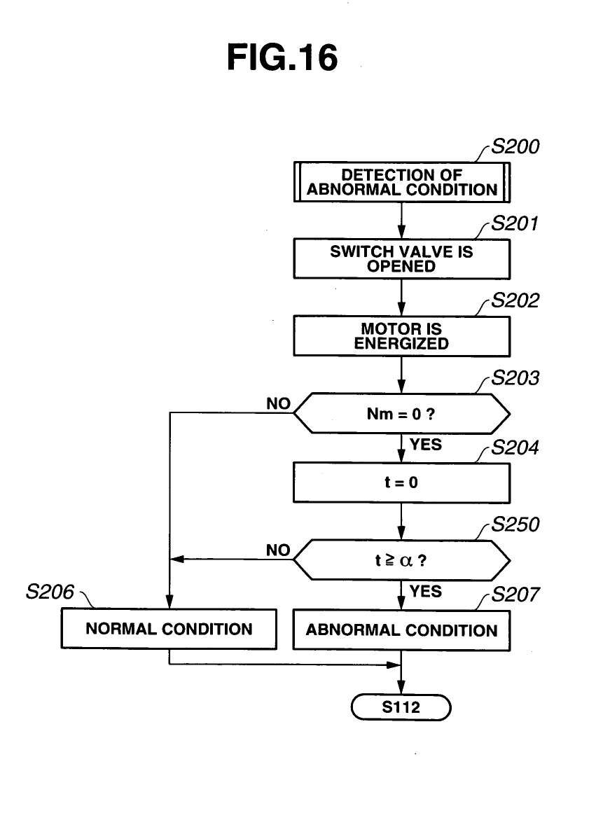

In the following, the detail of the abnormal condition detecting control at the above-mentioned step S111 will be described with reference to the flowchart of FIG. 16.

At step S201, electromagnetic switch valve 50 is opened, and the operation flow goes to step S202.

At step S202, electric motor 30 is energized. As has been mentioned hereinabove, this motor energization is carried out irrespective of work of torque sensor TS. Then, the operation flow goes to step S203.

At step S203, judgment is carried out as to whether the rotation speed of motor 30 is 0 (zero) or not. If YES, the operation flow goes to S204 judging that any trouble might take place in the device. If NO, that is, when the motor 30 runs at a certain speed, the operation flow goes to step S206 judging that no trouble takes place in the device. Then, the operation flow goes to the above-mentioned step S112 (see FIG. 15).

At step S204, a time counter is set to 0 (zero) for measuring a time “t” elapsed therefrom. Then, the operation flow goes to step S205.

At step S205, judgment is carried out as to whether or not the elapsed time “t” is equal to or longer than a predetermined time “a”, If YES, that is, when the elapsed time “t” is judged equal to or longer than the predetermined time “a”, the operation flow goes to step S207 judging that any trouble has taken place in the device. Then, the operation flow goes to the above-mentioned step S112.

While, if NO at step S205, that is, when the elapsed time “t” is judged shorter than the predetermined time “α”, the operation flow goes to step S206 judging that no trouble has taken place in the device. Then, the operation flow goes to the above-mentioned step S11.

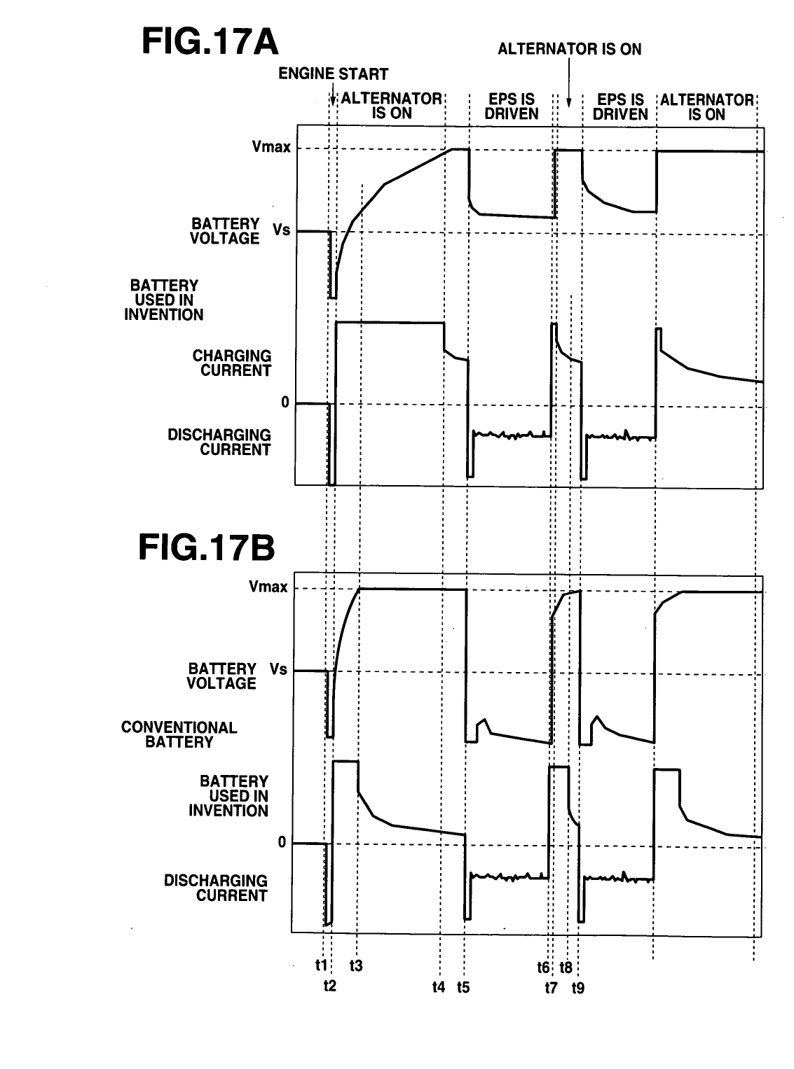

In the following, the performance of battery unit 10 employed in the invention will be described with reference to FIG. 17A. Actually, FIG. 17A is a time chart showing changes of a battery voltage, a battery charging current and a battery discharge current. For comparison, the performance of a conventional battery is shown in FIG. 17B.

At time “t1”, an ignition switch is turned ON. Upon this, a self-starting motor (not shown) is energized for starting the engine. Thus, as is seen from the two graphs, both batteries show a certain voltage drop from an engine OFF time value “Vs”. It is to be noted that this engine OFF time value “Vs” is the voltage value appearing when the engine is in OFF condition.

At time “t2”, the engine is started and the generator starts to generate an electric power. As is seen from the two graphs, both batteries start to charge and thus the battery voltage “V” starts to rise.

At time “t3”, charging of the conventional battery is ended and the battery voltage “V” shows the maximum value “Vmax”. As is seen from FIG. 17B, upon this, in case of the conventional battery, the charging current is reduced for avoiding an overcharge.

It is to be noted that in case of battery unit 10, the battery voltage “V” is still increasing at time “t3”. This means that battery unit 10 has a sufficient capacity as compared with the conventional one.

At time “t4”, charging of battery unit 10 is ended and the battery voltage “V” shows the maximum value “Vmax”. Upon this, the charging current is reduced.

At time “t5”, a steering operation by a driver starts and thus electric motor 30 is energized to start the steering assist. Due to operation of electric motor 30, the battery voltage is reduced in both battery unit 10 and the conventional battery.

However, as is seen from the two graphs, the reduction degree of battery voltage is small in battery unit 10 as compared with the conventional battery. That is, as is seen from the FIG. 17A, in case of battery unit 10, the reduced battery voltage is higher than the engine OFF time value “Vs”. While, in case of the conventional battery (see FIG. 17B), the reduced battery voltage is lower than the engine OFF time value “Vs”.

At time “t6”, the steering operation by the driver ends and thus electric motor 30 is deenergized, and charging of the battery by the alternator is started again. As is seen from the graphs, in battery unit 10, the battery voltage “V” instantly reaches the maximum value “Vmax” upon starting of the charging. While, in the conventional battery, a certain time lag appears until reaching the maximum value “Vmax”.

At time “t7”, charging of battery unit 10 is saturated and the charging current is reduced. However, in case of the conventional battery, charging of the battery is not saturated yet, and thus the charging current is not reduced.

At time “t8”, charging of the conventional battery is saturated and the charging current is reduced.

From time “t9”, the phenomena taken from time “t5” to time “t8” are repeated.

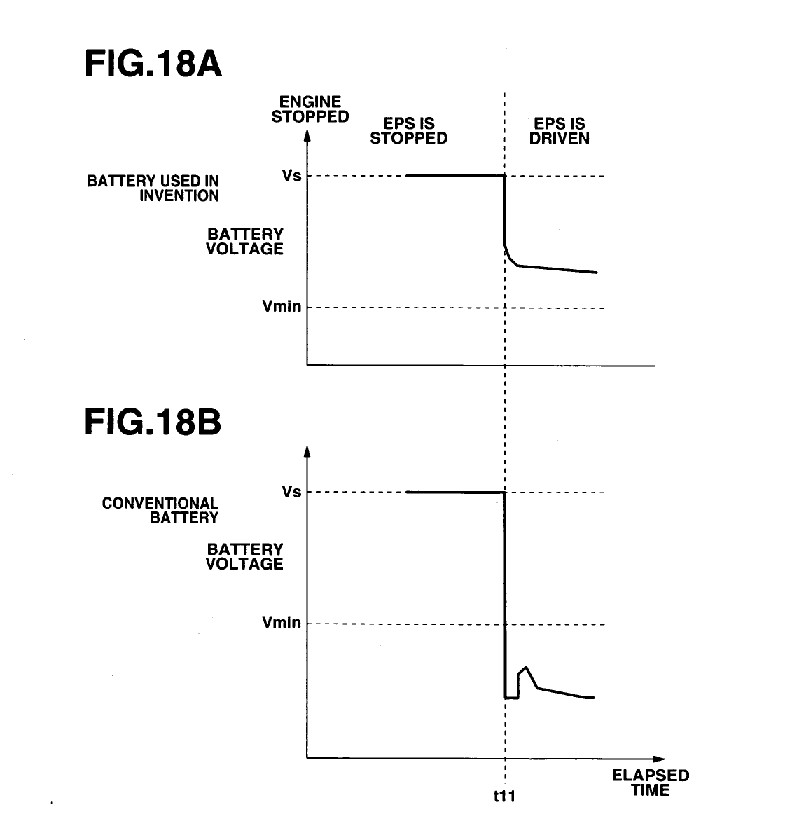

In the following, with the aid of FIGS. 18A and 18B, description will be made on the characteristics of the batteries in case wherein the steering assist is effected under stopping of the engine. FIG. 18A shows the characteristic of battery unit 10 and FIG. 18B shows the characteristic of the conventional battery.

In the graphs, “Vs” represents the engine OFF time value of the battery voltage, and “Vmin” represents the minimum voltage that is needed for driving electric motor 30.

At time “t11”, a steering operation by a driver starts and thus electric motor 30 is energized to start the steering assist. Due to operation of electric motor 30, the battery voltage is reduced in both battery unit 10 and the conventional battery.

However, as is seen from the two graphs, the reduction degree of battery voltage is small in battery unit 10 as compared with the conventional battery. That is, as is seen from FIG. 18A, in case of battery unit 10, the reduced battery voltage is higher than the minimum value “Vmin”. While, in case of the conventional battery (see FIG. 18B), the reduced battery voltage is lower than the minimum value “Vmin”.

This means that in case of the conventional battery, the steering assist under OFF condition of the engine is not expected. While, in case of battery unit 10, such steering assist is achieved.

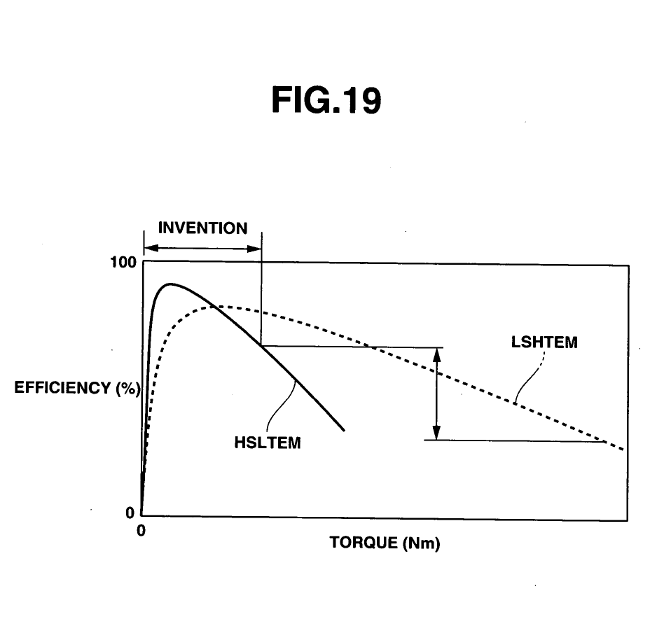

Referring to FIG. 19, there is shown a graph that depicts characteristics of a high speed low torque electric motor (HSLTEM) and those of a low speed high torque electric motor (LSHTEM). As shown in the graph, in case of the high'speed low torque electric motor, a higher efficiency is obtained but the efficiency is rapidly lowered with increase of torque. While, in case of the low speed high toque electric motor, a torque variation is small but the efficiency is low. In the present invention, the high speed low torque type motor is used as electric motor 30. Preferably, in the invention, driving hydraulic pump 20 is made by using only the high speed high efficiency operation range of motor 30. In using such range, a voltage drop of battery tends to affect the rotation speed of the motor 30. However, since battery unit 10 used in the invention is of the type that has a less voltage drop, stable operation of the motor 30 is achieved.

In the following, advantageous features of the invention will be described.

(1) In the power steering device of the invention, hydraulic pump 20 is driven by electric motor 30 to charge or discharge a hydraulic fluid to or from hydraulic power cylinder 6. Control unit 40 is employed for controlling the current fed to electric motor 30. As an electric power source, there is employed a battery unit 10 that includes a plurality of lead-acid batteries each being of a spirally wound type. The spirally wound type lead-acid battery comprises a spirally wound positive plate 110, a spirally wound negative plate 120 and a spirally wound insulating plate 130 that is sandwiched between positive and negative plates 110 and 120. These spirally wound plates 110, 120 and 130 are concentrically disposed in a cylindrical battery case 140 that is filled with an electrolyte.

As is described hereinabove, the battery unit 10 shows a less voltage drop and thus for the reasons as mentioned hereinabove, the power steering device of the invention can produce a stable and sufficient steering assist force. This type power steering device is applicable to various types of motor vehicles which are for example a small sized motor vehicle that needs only a small steering assist force and a large sized motor vehicle that needs a large steering assist force.

(2) In the power steering device of the invention, electric motor 30 employed comprises stator 310 and rotor unit 320. Stator 310 comprises stator cores 311 each having a stator coil 312 wound thereon. Terminal ends of stator coils 312 are connected to given portions of connecting rings 313 to which power cables 341 from power module 410 are connected. Rotor unit 320 comprises output shaft 321 and a plurality of magnets 322 that are arranged to surround output shaft 321.

With this arrangement, larger current can be fed to electric motor 30 to permit the same to produce a larger and sufficient output.

(3) Because of usage of the spirally wound plates 110, 120 and 130, each lead-acid battery 100 can produce a higher electric power per unit volume.

(4) In electric motor 30 driven by the three-phase alternating current produced by power module 410, a so-called delta wiring is employed for connecting coils 312 of stator cores of U-, V- and W-phase groups. Thus, size reduction of stator 310 is achieved.

(5) Control unit 40 comprises power module 410, control module 420 and connector module 430 which are arranged in the above-mentioned manner. Connector module 430 comprises bus bars B that are connected to power module 410, and filters F1 and F2 and condensers C1 and C2 that are connected to the bus bars B. Usage of bus bars B makes it possible to carry a heavy direct current from battery unit 10 to power module 410.

(6) In the power steering device of the invention, first and second hydraulic passages 51 and 52 from hydraulic pump 20 are lead to first and second work chambers 61 and 62 of hydraulic power cylinder 6 respectively, and electromagnetic switch valve 50 is arranged between first and second hydraulic passages 51 and 52. When any trouble occurs in the device, control unit 40 causes electromagnetic switch valve 50 to take its open condition. With this, a so-called manual steering by a driver is smoothly made.

(7) In the power steering device of the invention, hydraulic power cylinder 6 for powering rack 4 connected to steered front road wheels FR and FL has first and second work chambers 61 and 62. First and second intake/exhaust ports 210 and 220 of hydraulic pump 20 are connected to first and second work chambers 61 and 62 through first and second hydraulic passages 51 and 52. Electric motor 30 drives hydraulic pump 20 to rotate in both directions. Between first and second hydraulic passages 51 and 52, there is arranged electromagnetic switch valve 50 that selectively opens and closes a direct connection between the passages 51 and 52. Based on information signals from various sensing means, control unit 40 controls operation of electric motor 30 and switch valve 50 in the above-mentioned manner. For powering electric motor 30, the battery unit 10 including the spirally wound type lead-acid batteries 100 is used.

Thus, a driving torque produced by electric motor 30 is transmitted to steered front wheels FR and FL through the hydraulic power mechanism. Thus, in the invention, much assured and large steering assist force is produced.

(8) As is described hereinabove, upon failure of the power steering device, electromagnetic switch valve 50 is forced to take its open position to directly connect first and second hydraulic passages 51 and 52. Thus, a so-called manual steering operation by the driver is easily and safely carried out.

(9) At the time of checking the power steering device by driving hydraulic pump 20, switch valve 50 is turned to its open position. Thus, undesired steered movement of steered front wheels FR and FL against the driver's will is suppressed.

(10) Due to provision of abnormal condition detection inhibiting section 423a in control unit 40, excessive voltage drop of battery unit 10 is suppressed and at the same time, misdiagnosis for electric motor 30 by abnormal condition detecting section 423 is suppressed.

(11) Because of usage of spirally wound type lead-acid batteries 100 for battery unit 10, operation of the power steering device is expected even in OFF condition of the engine. Even when, like in a time just after engine starting, the alternator is not in the condition to generate a sufficient quantity of electricity, the battery unit 10 can sufficiently operate electric motor 30 and thus operate the power steering device.

(12) Due to provision of engine operation condition detecting section 421 in control unit 40, the target current value “It” to be fed to electric motor 30 is reduced when the engine is in OFF condition. With this, excessive voltage drop of battery unit 10 is suppressed.

(13) Due to provision of engine operation condition detecting section 421 and alarm control section 422 in control lo unit 40, warning lamp 8 is turned on when, with the engine being in OFF condition, a steering action is made by a driver.

(14) Due to provision of steering control inhibiting section 424a in control unit 40, undesired steering action by the driver under OFF condition of the engine is suppressed.

(15) Due to provision of steering control inhibiting section 424a, the target current value “It” fed to electric motor 30 is gradually reduced when the battery voltage “V” shows a value lower than the predetermined lower value “Va”. With this, the power assist can be smoothly ended without deteriorating the steering feeling that the driver has.

The entire contents of Japanese Patent Application 2005-290069 filed Oct. 3, 2005 are incorporated herein by reference.

Although the invention has been described above with reference to the embodiment of the invention, the invention is not limited to such embodiment as described above. Various modifications and variations of such embodiment may be carried out by those skilled in the art, in light of the above description.

What is claimed is:

1. A power steering device of a motor vehicle which has a steering wheel and steered road wheels, comprising:
a steering mechanism through which turning of the steering wheel is transmitted to the steered road wheels of the vehicle;
a power assist mechanism that assists the operation of the steering mechanism when receiving a pressurized hydraulic fluid;
a hydraulic pump that feeds the power assist mechanism with the pressurized hydraulic fluid when driven;
an electric motor that drives the hydraulic pump when energized;
a battery unit that produces an electric power for energizing the electric motor;
a sensor member that senses both a toque applied to the steering mechanism through the steering wheel and a direction in which the steering wheel is turned; and
a control unit that controls operation of the electric motor, the control unit being configured to control the electric power fed from the battery unit to the electric motor in accordance with the torque and the direction sensed by the sensor;
wherein the battery unit comprises a plurality of lead-acid batteries that are connected in series, each lead-acid battery including a spirally wound positive plate, a spirally wound negative plate, a spirally wound insulating plate that is spirally wound and sandwiched between the positive and negative plates, a cylindrical battery case that puts therein the spirally wound positive, negative and insulating plates and an electrolyte that is provided in the cylindrical battery case.

2. A power steering device as claimed in claim 1, in which the spirally wound positive plate of each lead-acid battery has an area of approximately 1,500 to 15,000 cm².

3. A power steering device as claimed in claim 1, in which the number of the lead-acid batteries is so determined as to cause the battery unit to produce an electric power of voltage of 14V.

4. A power steering device as claimed in claim 1, in which the number of the lead-acid batteries is so determined as to cause the battery unit to keep a voltage higher than 12V even if an electric discharge in the scale of 100 A takes place.

5. A power steering device as claimed in claim 1, in which the control unit comprises:
a power module that serves as an inverter and includes a plurality of semi-conductor switching elements;
a control module that controls the power module; and
a connector module electrically connected to the power module,
wherein the connector module includes bus bars connected to the power module and circuit parts that are connected to the bus bars,
wherein the bus bars constitute part of a circuit through which a direct current electric power produced by the battery unit is transmitted to the power module;
wherein the circuit parts are filters and condensers; and
wherein the filters and condensers have terminals that are connected to the bus bars by welding.

6. A power steering device as claimed in claim 1, in which the power assist mechanism comprises:
a hydraulic power cylinder having therein an axially movable piston by which the interior of the cylinder is divided into first and second work chambers which are connected to first and second intake/exhaust ports of the hydraulic pump via a pair of hydraulic passages respectively;
a rack that is connected to the piston to move therewith, the rack being connected to the steered road wheels and meshed with a pinion rotated by the steering wheel;
a bypass hydraulic passage extending between the pair of hydraulic passages; and
a switch valve disposed in the bypass hydraulic passage, the switch valve being opened upon receiving an abnormal condition representing signal from the control unit.

7. A power steering device of a motor vehicle which has a steering wheel and steered road wheels, comprising:
a steering mechanism through which turning of the steering wheel is transmitted to the steered road wheels;
a hydraulic power cylinder having first and second work chambers defined therein, the power cylinder assigning the operation of the steering mechanism when receiving a pressurized hydraulic fluid in one of the first and second work chambers;
a reversible hydraulic pump that has first and second intake/exhaust ports that are connected to the first and second work chambers of the hydraulic power cylinder respectively, the reversible hydraulic pump feeding one of the first and second work chambers with the pressurized hydraulic fluid when rotated in either one of normal and reversed directions;
a three-phase electric motor that drives the reversible hydraulic pump when energized by a three-phase alternating current electric power;
a battery unit that produces a direct current electric power;
a sensor member that senses both a torque applied to the steering mechanism through the steering wheel and a direction in which the steering wheel is turned; and
a control unit that is energized by the electric power and controls operation of the three-phase electric motor,
wherein the control unit includes a section that inverts the direct current electric power from the battery unit to the three-phase alternating current electric power fed to the electric motor, and a section that controls the electric power from the battery unit to the electric motor in accordance with the torque and the direction that are sensed by the sensor member.

8. A power steering device as claimed in claim 7, in which the electric motor comprises a stator, a rotor unit rotatably received in the stator and three terminal connecting rings, the stator including a plurality of stator cores each having a stator coil wound thereon, terminal ends of the stator coils being connected to given portions of the three terminal connecting rings.

9. A power steering device as claimed in claim 8, in which the three terminal connecting rings are concentrically arranged at one axial end portion of the electric motor and fed with the three-phase alternating current electric power.

10. A power steering device as claimed in claim 9, in which the battery unit comprises a plurality of lead-acid batteries that are connected in series, each lead-acid battery including a spirally wound positive plate, a spirally wound negative plate, a spirally wound insulating plate that is spirally wound and sandwiched between the positive and negative plates, a cylindrical battery case that puts therein the spirally wound positive, negative and insulating plates and an electrolyte that is provided in the cylindrical battery case.

11. A power steering device of a motor vehicle which has a steering wheel and steered road wheels, comprising:
a steering mechanism through which turning of the steering wheel is transmitted to the steered road wheels;
a hydraulic power cylinder having first and second work chambers defined therein, the power cylinder assisting the operation of the steering mechanism when receiving a pressurized hydraulic fluid in one of the first and second work chambers;
a reversible hydraulic pump that has first and second intake/exhaust ports that are connected to the first and second work chambers of the hydraulic power cylinder respectively, the reversible hydraulic pump feeding one of the first and second work chambers with the pressurized hydraulic fluid when rotated in either one of normal and reversed directions;
an electric motor that rotates the reversible hydraulic pump in normal and reversed directions;
a battery unit including a plurality of lead-acid batteries that are connected in series, each lead-acid battery comprising a spirally wound positive plate, a spirally wound negative plate, a spirally wound insulating plate that is spirally wound and sandwiched between the positive and negative plates, a battery case that puts therein the spirally wound positive, negative and insulating plates and an electrolyte that is provided in the battery case;
a power module that controls an electric power that is produced by the battery unit and fed to the electric motor;
a steering load detecting section that detects a steering load that is applied to the steering mechanism through the steering wheel; and
a control module that controls the power module in accordance with the steering load detected by the steering load detecting section.

12. A power steering device as claimed in claim 11, further comprising:
an abnormal condition detecting section that drives the electric motor irrespective of presence or absence of the steering load and detects whether the power steering device has a trouble or not based on an operation condition of the electric motor; and
a bypass means that provides a fluid communication between the first and second work chambers during the time when the abnormal condition detecting section drives the electric motor.

13. A power steering device as claimed in claim 12, further comprising:
a voltage detecting section that detects the voltage of the battery unit; and
an abnormal condition detection inhibiting section that inhibits the operation of the abnormal condition detecting section when the voltage of the battery unit is lower than a predetermined level.

14. A power steering device as claimed in claim 11, in which the control module is configured to carry out the steering assist operation of the hydraulic power cylinder even when the engine is in its OFF condition.

15. A power steering device as claimed in claim 14, further comprising an engine operation condition detecting section that detects ON or OFF condition of the engine,
wherein when the engine operation condition detecting section detects OFF condition of the engine, the control module reduces the current fed to the electric motor to a level that is lower than that fed to the electric motor when the engine is in its ON condition.

16. A power steering device as claimed in claim 14, further comprising:
an engine operation condition detecting section that detects ON or OFF condition of the engine;
an alarm device that produces a visual or audible alarm when actuated;
an alarm control section that actuates the alarm device when the engine operation condition detecting device detects the OFF condition of the engine and a steering action is carried out by the steering mechanism.

17. A power steering device as claimed in claim 14, further comprising:
an engine operation condition detecting section that detects is ON or OFF condition of the engine;
a voltage detecting section that detects the voltage of the battery unit; and
a steering control inhibiting section that inhibits operation of the electric motor when the engine operation condition detecting section detects OFF condition of the engine and the voltage detecting section detects that the voltage of the battery unit is lower than a predetermined level.

18. A power steering device as claimed in claim 17, in which the steering control inhibiting section functions to gradually reduce the level of current fed to the electric motor when the voltage of the battery unit is lower than a predetermined level.
